(19) United States
(12) Patent Application Publication
(10) Pub. No.: US 2008/0251343 A1
(43) Pub. Date: Oct. 16, 2008

(54) Clutch System

(76) Inventor: Francis Maranda, Hull (CA)

Correspondence Address: CHALKER FLORES, LLP, 2711 LBJ FRWY, Suite 1036, DALLAS, TX, 75234, US

(21) Appl. No.: 11/574,668

(22) PCT Filed: Sep. 3, 2004
(86) PCT No.: PCT/CA04/01590

§ 371 Date: Jan. 9, 2008

(51) Int. Cl. F16D 13/71

(52) U.S. Cl. 192/70.11

(57) ABSTRACT

The present invention provides a pressure plate for a clutch system that has been modified such that the upper surface provides a plurality of recesses at circumferentially spaced-apart locations, preferably in equally radially spaced locations to form a circular array. Each recess is dimensioned to retain a shaft with a rotational bearing for free rotation and yet also permit axial movement of the rotational bearing along the shaft. The shaft and rotational bearing arrangement form a bearing contact between the pressure plate and the diaphragm. The rotational and axial movements occur when the diaphragm is flattened or curved for disengagement and engagement of the clutch disc, respectively. The axial movement permits the bearing to center itself on the shaft during the engagement and disengagement of the clutch disc, thus increasing the pressure capacity of the pressure plate. In this arrangement, the rotational bearing and the pressure plate depressed by the diaphragm when transitioning from a flattened to a curved shape and vice versa. The rotational bearing may be a spherical ball bearing or needle bearing for example.

### FIELD OF INVENTION

The present invention relates to a clutch system having a pressure plate in bearing contact with a spring diaphragm. More particularly, the present invention relates to a modified bearing forming the bearing contact between the pressure plate and the spring diaphragm.

### BACKGROUND OF THE INVENTION

In the typical automotive clutch, the clutch disc is supported between a pressure plate and the flywheel. A clutch housing cover which is attached to the flywheel surrounds the pressure plate and supports a spring diaphragm, also known as a Bellville diaphragm, which supplies the clamp load to compress the clutch disc between the pressure plate and flywheel when the clutch is engaged. The diaphragm has a fulcrum support on the clutch housing cover and the base of the diaphragm rests on a raised circular rim on the upper surface of the pressure plate. When the position of the diaphragm is reversed in its position between clutch engagement and disengagement, the base of the diaphragm rubs against this circular rim, with frictional losses that cause hysterisis in the clamp load between engagement and disengagement, and objectionable wear on the rim of the pressure plate.

The most common diaphragm clutches are the push-off type in which a force is applied downwardly against the center fingers of the diaphragm to cause it to move the pressure plate into a position disengaging the clutch disc. The need to minimize the size and bulk of automotive components has led to the development of the pull-off type clutch in which a lifting force is applied to the fingers of the diaphragm to release the pressure plate. In this clutch design, the base of the diaphragm rests against the underside of the clutch housing cover, and an annular area of the diaphragm bears against the raised rim on the pressure plate.

One issue with existing clutch systems, particularly in those used in racing vehicles is the pedal effort required to compress the spring diaphragm in order to engage the clutch. The bearing contact between the spring diaphragm and the pressure plate is one area where improvements could be made to reduce the pedal effort.

In the prior art, the Hays patent, U.S. Pat. No. 5,499,704, is a continuation-in-part of another Hays patent, U.S. Pat. No. 5,375,688. The '688 patent discloses a clutch diaphragm where its base is supported on a roller, which is either spherical balls or elongate rollers. Each roller is rotationally supported on a raised rim of the pressure plate. The rim retains the rollers in a circular array of corresponding recesses. In an alternative embodiment, the elongate rollers are received in a circular array of elongate recesses. The elongate recesses may be further modified to retain cylindrical rollers with a large diameter center tapering to two smaller diameter ends. While Hays '688 does teach the use of rotational rollers mounted in the pressure plate and in bearing contact with the diaphragm, the pressure of the spring diaphragm applied to the pressure plate of the bearing contact would prevent any rotation of the roller.

The '704 patent, also issued to Hays, provides for a ball retainer ring having a plurality of circumferentially spaced-apart balls, whereby the retainer ring is mounted on the upper surface of the pressure plate; the balls provide fulcrum support for the diaphragm. The improvement of the '704 patent over the '688 patent relates to ease in manufacturing a separate retainer ring with stationary balls for mounting to the pressure plate. However, the balls are permanently mounted in the retainer ring, and accordingly are not designed to move within the recess of the ring.

The British patent, GB 1 432 739, issued to Fichtel & Sachs AG., discloses a diaphragm spring clutch with reinforcement points mounted along the periphery of the pressure plate for supporting the diaphragm. The reinforcement points are disclosed as either balls (4) or cylindrical pins with convex end faces, as shown in FIGS. 1 and 2, respectively. In a further embodiment, the diaphragm is also provided with recesses to receive the convex end of the cylindrical pin in “punctiform contact”. The British patent teaches that the recesses are advantageous in providing a centering effect for the diaphragm over the pressure plate. However, the “punctiform contact” provides a fixed bearing contact where the ball or pin is lodged inside the recess. The cylindrical pin as taught in the British patent is transverse with respect to the diaphragm and pressure plate. Furthermore, the pin is not rotational when the diaphragm transitions between the engaged and disengaged states.

The teachings of the first issued Hays patent, and the British patent, assigned to Fichtel & Sachs, teach a modified pressure plate as circumferential spaced-apart arrangement of cylindrical pins, balls, or rollers to form a bearing contact with the clutch diaphragm. However, there is a need in the prior art to provide a further pivot for the base end of the spring diaphragm due to the amount of pressure applied to the balls and rollers by the spring diaphragm. The amount of pressure applied on the balls or rollers in conventional clutch systems would prevent any possible rotation thereof. Therefore, there exists a need for a bearing that rotates as the spring diaphragm is shaped for clutch engagement and disengagement.

### SUMMARY OF THE INVENTION

In view of the aforementioned shortcomings of the prior art, the present invention seeks to provide a modified pressure plate with circumferentially spaced-apart recesses that each retain a modified bearing such that it is axially and rotationally movable. The modified bearings facilitate the shaping of the spring diaphragm during engagement and disengagement of the clutch disc.

The present invention seeks to provide a clutch system for vehicles, particularly racing vehicles, where the amount of force applied to the pressure plate is critical with increased engine speed. The present invention is a modification of the prior art clutch system, and in particular of the pressure plate in bearing contact with the spring diaphragm. The prior art pressure plate is typically formed of an annular ring with a smooth undersurface, a plurality of angularly spaced bosses for coupling with the clutch cover, and an upstanding rim on the upper surface of the plate. The clutch diaphragm is then mounted below the clutch cover onto the pressure plate so as to exert an axial force on the clutch disc through direct contact with the pressure plate when the diaphragm is flattened for engagement. The axial force applied to the clutch disc is released when the diaphragm is curved to force the pressure plate out of engagement with the clutch disc.

According to the present invention, the pressure plate has been modified such that the upper surface provides a plurality of recesses at circumferentially spaced-apart locations, preferably in equally radially spaced locations, to form a circular array. Each recess is dimensioned to retain a shaft with a rotational bearing for free rotation and yet also permit axial movement of the rotational bearing on the shaft. The shaft and rotational bearing arrangement are in bearing contact with the pressure plate and the diaphragm. The rotational and axial movement occurs when the diaphragm is flattened or curved for engagement and disengagement of the clutch disc, respectively. In this arrangement, the rotational bearing provides fulcrum support for the diaphragm when transitioning from a flattened to a curved shape and vice versa. The rotational bearing, which may be a spherical ball bearing or needle bearing for example, is axially movable along the shaft. The axial movement permits the bearing contact to center itself on the shaft during the engagement and disengagement of the clutch disc. By centering the rotational bearing along the shaft, uniform pressure is applied across the pressure plate thus increasing the pressure capacity of the pressure plate. The shaft and bearing arrangement enables the clutch system to exert greater transfer of force on the pressure plate than in the prior art clutch systems as friction loss at the bearing contact is minimized. As such, the present invention is advantageous for racing vehicles or high performance vehicles, as well as transportation and farming vehicles, where the amount of pressure applied to engage and disengage the clutch system is increased due to the increased pressure capacity of the pressure plate.

The shaft with a bearing that is axially movable within the recesses of the pressure plate is not disclosed in the prior art. Moreover, while the prior art teach various types of bearings, the exact physical structure of the shaft and rotational bearing as contemplated in the present invention is not disclosed in any of the prior art relating to clutch systems.

The present invention is advantageous in that the use of a rotational bearing helps to reduce the clutch pedal force required by the user to engage the pressure plate due to the rotation of the rotational bearing on the shaft. Furthermore, the present invention is advantageous in that a more precise fulcrum point of release of the pressure plate when the spring diaphragm is decompressed. Hence, the pressure applied to the pressure plate is uniform across the plate through the centering effect of the rotational bearing in contact with the diaphragm.

In a first aspect, the present invention provides an automotive clutch system having a clutch disc supported by a flywheel and a pressure plate with a spring diaphragm biased by a release mechanism operating between the pressure plate and a clutch cover to compress the clutch disc between the pressure plate and the flywheel in engagement and to release the clutch disc from the flywheel in disengagement, the pressure plate in bearing contact with the spring diaphragm, the pressure plate forming a substantially annular ring with an undersurface to engage the clutch disc, and an upstanding rim on an upper surface of the pressure plate, wherein the release mechanism comprises: a plurality of shafts and corresponding rotational bearings as the bearing contact, each shaft and corresponding rotational bearing arranged such that the rotational bearing is mounted on the shaft for rotational movement about the shaft; and the pressure plate having radially spaced apart recesses in the upper surface of the pressure plate for retaining each shaft and corresponding rotational bearing for free rotation about the shaft, the rotational bearing and the pressure plate being vertically displaced as the spring diaphragm is shaped for engagement and disengagement of the clutch disc.

In a second aspect, the present invention provides an automotive clutch system having a clutch disc supported by a flywheel and a pressure plate with a spring diaphragm biased by a release mechanism operating between the pressure plate and a clutch cover to compress the clutch disc between the pressure plate and the flywheel in engagement and to release the clutch disc from the flywheel in disengagement, the pressure plate forming a substantially annular ring with an undersurface that engages the clutch disc, and the pressure plate having an upstanding rim on an upper surface of the pressure plate, the spring diaphragm being shaped for engagement and disengagement, the pressure plate in bearing contact with a base end of the spring diaphragm such that the spring diaphragm is shaped for engagement to transfer a force through the release mechanism to the pressure plate to engage the clutch disc, and when shaped for disengagement, releases the transfer of force to the pressure plate via the release mechanism, wherein the release mechanism comprises: a fulcrum support extending from the clutch cover and operatively coupled to a diaphragm spring such that the base end of the spring diaphragm is movable from the fulcrum support to displace the pressure plate; a plurality of shafts and corresponding rotational bearings as the bearing contact, each shaft and corresponding rotational bearing arranged such that the bearing is mounted on the shaft for rotational movement about the shaft; and the upstanding rim of the pressure plate defining radially spaced apart recesses in the upper surface of the pressure plate for retaining the each shaft and corresponding rotational bearing for free rotation about the shaft.

### BRIEF DESCRIPTION OF THE DRAWINGS

The present invention will now be described with reference to the drawings in which:

FIG. 1 is an elevational sectional view of a typical push-off type automotive clutch of the prior art;

FIG. 2 is a plan view of the area of the upper surface of the pressure plate of an automotive clutch of the prior art;

FIG. 3 is an enlarged view of the area within the box marked 3-3 of FIG. 2 of the prior art;

FIG. 4 is a plan view of the area of the upper surface of the pressure plate of an automotive clutch of the prior art utilizing elongate rollers;

FIG. 5 is an enlarged view of the area within the box marked 5-5 of FIG. 4;

FIG. 6 is a side sectional view of the clutch system in disengagement according to a first embodiment of the present invention;

FIG. 7 is an exploded view of the bearing contact of FIG. 6 illustrating movement of the bearing contact in a clockwise direction relative to the spring diaphragm;

FIG. 8 is a side sectional view of the clutch system in engagement according to the first embodiment of the present invention;

FIG. 9 is a partial cross sectional view of a shaft and rotational bearing of the first embodiment of the present invention;

FIG. 10 is a cross sectional view of the shaft rotational bearing taken along line 10-10 of FIG. 9;

FIG. 11 is a cross sectional of view of the shaft and rotational bearing taken along line 11-11 of FIG. 9;

FIG. 12 is a plan view of a modified pressure plate according to a second embodiment of the present invention;

FIG. 13 is a side sectional view of the modified pressure plate taken along line 13-13 of FIG. 12;

FIG. 14 is a plan view of a modified pressure plate according to a third embodiment of the present invention;

FIG. 15 is a side sectional view of the modified pressure plate taken along line 15-15 of FIG. 14;

FIG. 16 is a plan view of a modified pressure plate according to a fourth embodiment of the present invention;

FIG. 17 is a side sectional view of the modified pressure plate taken along line 17-17 of FIG. 16; and

FIG. 18 is a partial cross-sectional view of a shaft and rotational bearing of a fifth embodiment of the present invention.

### DETAILED DESCRIPTION OF THE INVENTION

The invention will be described for the purposes of illustration only in connection with certain embodiments. However, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

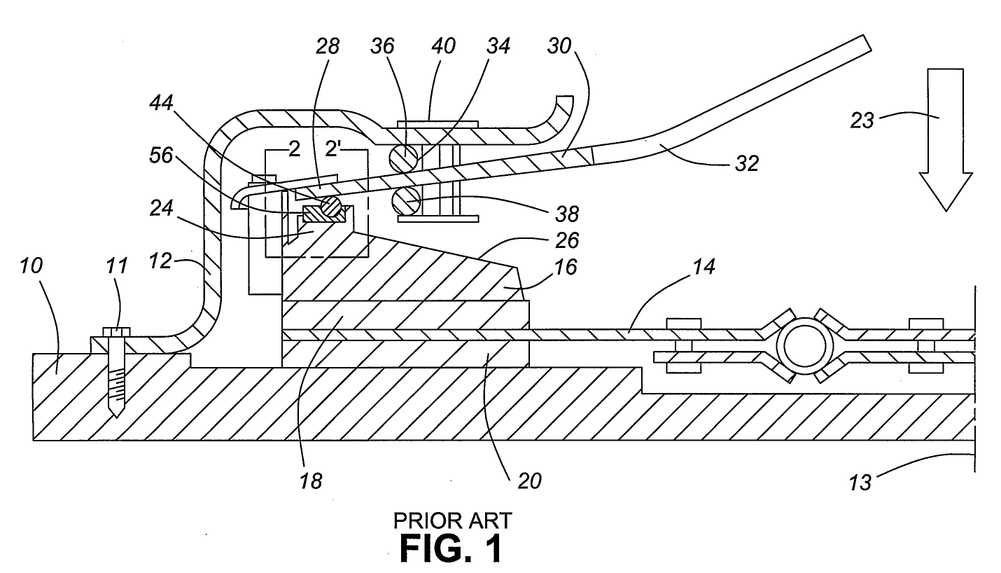

FIG. 1 of the prior art shows a sectional view of a conventional automotive clutch. The clutch is mounted on a flywheel 10 with a clutch cover 12 that surrounds the assembly and which is fastened to the flywheel by conventional machine screws 11. The clutch assembly is oriented on the center line 13 of the flywheel 10. A clutch disc 14 is located between the flywheel 10 and the pressure plate 16. Frictional facings 18 and 20 are provided on opposite sides of the clutch disc 14 and engage surfaces on the flywheel 10 and the pressure plate 16. The pressure plate 16 has a raised annular rim 24 on its upper surface 26 which provides a support for the base 28 of the diaphragm 30. The diaphragm 30 is a Bellville conical spring diaphragm which has a plurality of radial slots 32, forming a plurality of fingers. The diaphragm 30 has a fulcrum support 34 on the undersurface of the clutch housing cover 12 which is formed by a pair of rings 36 and 38 which are located above and below the diaphragm 30 and supported by a metal fastener 40 that extends through the housing cover 12. The arrow 23 indicates the direction of the release force to disengage the clutch, hence the name “throw-in” clutch, or pull-off type clutch.

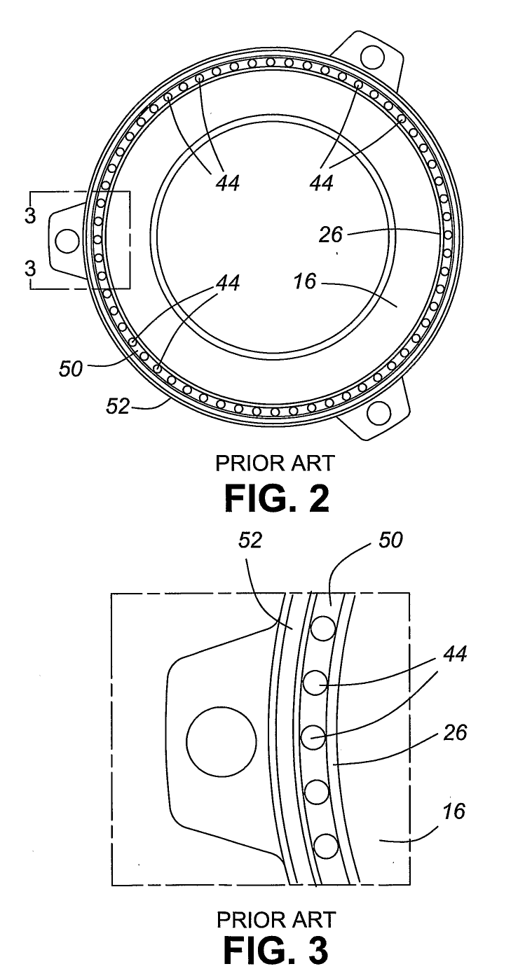

FIG. 1 of the prior art also shows a ball retainer 56 which is a ring having a plurality of spaced apart apertures which receive the balls 44 as shown in FIG. 2. When the balls 44 are seated in individual spherical recesses, rather than in a circular groove, the ring 56 is not necessary. When the balls are seated in a circular groove such as groove 50 and 52, the retainer ring is quite useful in retaining the balls 44 at their initial spacings. The ring rests on the upper edge 46 of the raised circular rim 24 and insures that the balls remain at the preset incremental angular spacing.

Referring to FIGS. 2 and 3 of the prior art, the arrangement of the balls in the innermost circular groove 50 of the pressure plate 16 is illustrated. In the illustration, the balls 44 are located at equally spaced apart angular increments. As previously mentioned, the balls can be retained at equal angular spacings by various retainer means, such as the retainer ring 56, as shown in FIG. 1 of the prior art. For clarity of illustration, the retainer ring 56 is not illustrated in FIGS. 2 and 3.

In this prior art application the upper edge 46 of the raised circular rim 24 is provided with a plurality of cylindrical walled recesses 58 at equal angular increments. An outer circular array 60 of recesses 58, and an inner circular array 62 of recesses 58 can be provided. The recesses are elongated and have cylindrical side walls 64, as shown in FIG. 5, to receive rollers 66, which are placed in each recess of either the inner circular array 62 or the outer circular array 60.

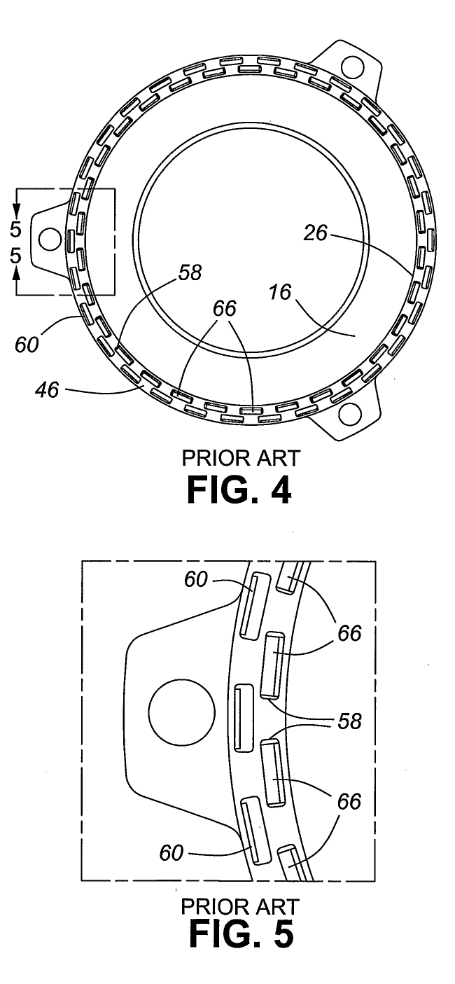

Preferably the rollers are right cylindrical rollers, as illustrated in FIGS. 4 and 5 of the prior art. According to the prior art, the rollers can also have a large diameter center and tapering to smaller diameter ends. These surfaces are taught as conical, or can be curvilinear as required.

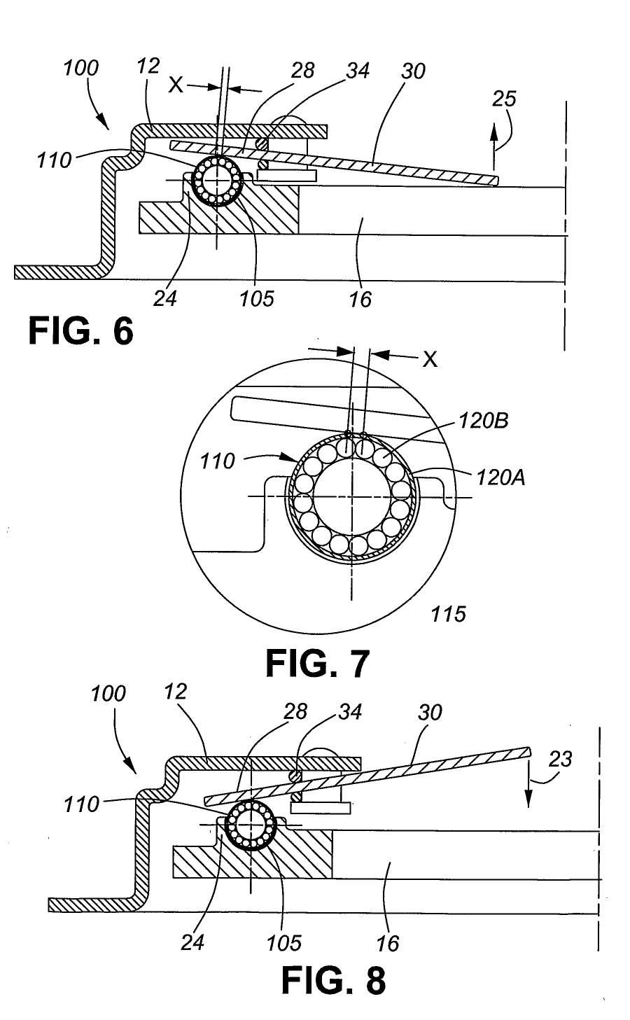

Referring now to the present invention, FIG. 6 is a side sectional view of the clutch system 100 in disengagement according to a first embodiment of the present invention. While not all elements required to operate the clutch system 100 are shown, it is assumed that the skilled artisan is knowledgeable in that regard. In FIG. 6, the clutch system 100 shown includes a clutch cover 12, a pressure plate 16 with an annular ring 24, a spring diaphragm 30, and the shaft and rotational bearing arrangement 110 of the present invention. The shaft and rotational bearing form a bearing contact between the base of the spring diaphragm and the surface 105 of the annular ring 24 of the pressure plate 16. As discussed earlier with reference to the prior art, to engage the clutch system 100 such that the spring diaphragm 30 acts as “a first class lever”. The fulcrum support 34, forming part of the clutch cover 12, acts a pivot point and lies between an inner end of the diaphragm where force is applied to generally flatten the diaphragm and the base 28 of the diaphragm 34 where the load is moved. The fulcrum support 34 includes a rivet 35 for coupling the cover 12 to the diaphragm 30. The load is effectively the shaft and rotational bearing arrangement 110 and pressure plate 16 which are displaced such that the pressure plate 16 disengages the clutch disc (not shown). The arrow 25 indicates the direction of the force to engage the clutch system.

FIG. 8 is a side sectional view of the clutch system in engagement according to the first embodiment of the present invention. To disengage the clutch system, a release force indicated by arrow 23 is shown. As force is applied to the diaphragm 30 at its inner end, the diaphragm 30 is generally shaped into a slight curve with the inner end moving close to the pressure plate 16. The upward movement of the base 28 of the diaphragm 30 toward the clutch cover 12 permits the pressure plate 16 to disengage from the clutch disc (not shown).

FIG. 7 is an exploded view of the shaft and rotational bearing arrangement 110 forming bearing contact of FIG. 6. The shaft and rotational bearing arrangement 110 comprises a shaft 115 and rotational bearing 120. As is understood by the skilled artisan, the rotational bearing 120 further comprises rollers 120A and a bearing cage 120B for permitting the rotation of the rotational bearing 120 about the shaft 115. FIG. 7 illustrates the displacement X of the rotational bearing 120 in a clockwise direction relative to the shaft 115. This is an important aspect of the present invention in that the displacement of the rotational bearing reduces the amount of clutch pedal force required by the user to push the diaphragm 30 for disengagement of the clutch disc, as well as the amount of pressure applied to the pressure plate.

It should be readily understood by the skilled artisan how the clutch pedal force relates to the force required to push the diaphragm.

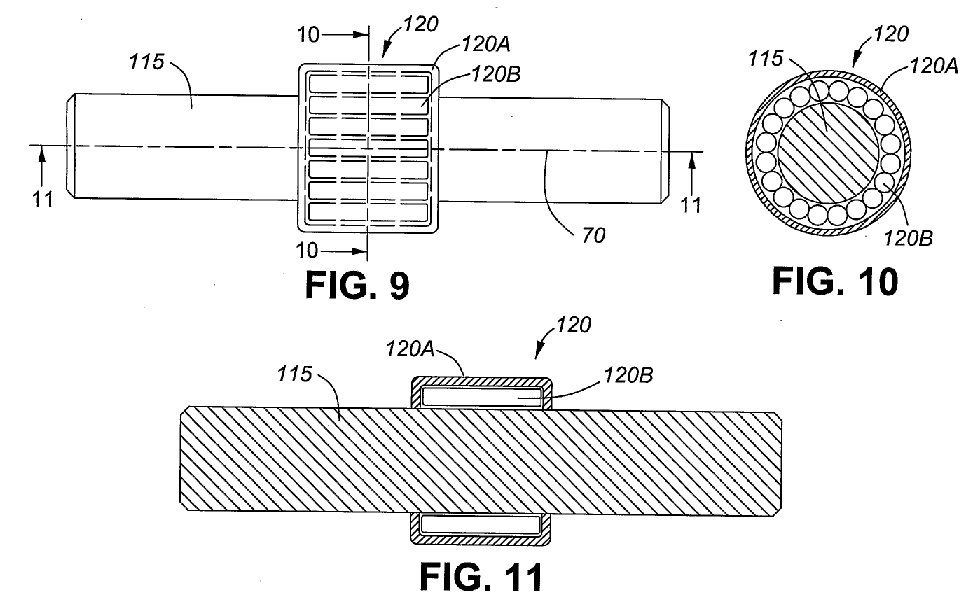

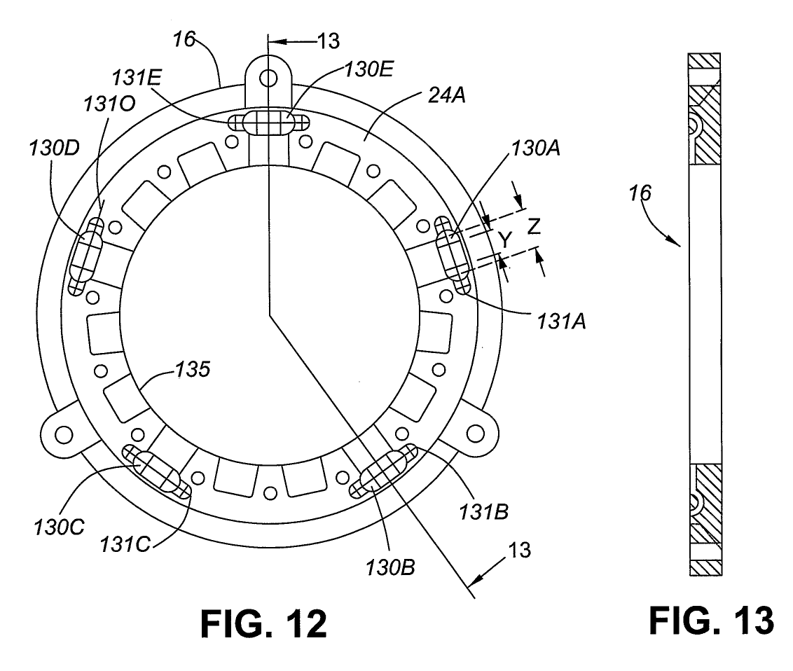

FIG. 9 is a partial cross sectional view of the shaft and the rotational bearing of a first embodiment of the present invention. The rotational bearing shown is also known in the art, as a needle bearing. The rotational bearing 120 and the shaft 115 may be any suitable dimension provided the corresponding recess formed in the pressure plate is dimensioned to retain the rotational bearing 120 and the shaft 115. The rotational bearing 120 is mounted on the shaft 115 for rotational movement of the shaft 115. A further embodiment of the present invention is dimensioning the corresponding recess in the pressure plate (shown in FIG. 12) to permit axial movement along the shaft. The axial movement of the rotational bearing enables the rotational bearing to center itself as pressure is applied at the bearing contact by the spring diaphragm 30. The centering of rotational bearing ensures that a uniform pressure is applied to the pressure plate.

FIG. 10 is a cross sectional view of the shaft 115 and the rotational bearing 120 taken along line 10-10 of FIG. 9. FIG. 11 is a further cross sectional of view of the shaft 115 and the rotational bearing 120 taken along line 11-11 of FIG. 9.

FIG. 12 is a plan view of a pressure plate 24 with a modified annular rim 24A according to a second embodiment of the present invention. FIG. 13 is a side sectional view of the modified pressure plate 24 taken along line 13-13 of FIG. 12. The modified annular rim has a plurality of recesses 130A, 130B, . . . , 130E, for each corresponding shaft and rotational bearing, as shown in FIG. 9. Each of the plurality of recesses 130A, 130B, . . . , 130E define a longitudinal axis 131A, 131B, . . . , 131E that is tangential to the outer circumference of the annular ring 24A. Each recess 130A, 130B, . . . , 130E may be further dimensioned to permit axial movement of the rotational bearing (not shown) along its respective longitudinal axis 131A, 131B, . . . , 131E. For example, the corresponding rotational bearing (not shown) for recess 130A has a longitudinal length Y and the bearing portion of the recess 130A has a longitudinal length of Z, thus permitting axial movement of the rotational bearing along the corresponding shaft (not shown).

The rotational and axial movements occur when the diaphragm 30 (as shown in FIGS. 6, 8) is flattened or curved for disengagement and engagement of the clutch disc, respectively. The axial movement permits each bearing to center itself on the shaft during the engagement and disengagement of the clutch disc, thus increasing the pressure capacity of the pressure plate. In this arrangement, the rotational bearing and the pressure plate 16 are depressed by the diaphragm 30 when transitioning from a flattened to a curved shape and vice versa.

While each recess of FIG. 12 is shown as having the same dimensions, the length of the recess for each shaft and each rotational bearing along the longitudinal axis 131A, 131B, . . . , 131E, may vary between the five recesses 130A, 130B, . . . , 130E. However, as the pressure applied at the bearing contact should be uniform across the pressure plate, the circumferential dimensions of each shaft and each rotational bearing should be the same.

The pressure plate 16 further provides a cavity 135 for clearing rivets when the clutch system is engaged as shown in FIG. 6 as element 35. While the pressure plate of the present invention does not require a cavity, it may be included as an additional feature.

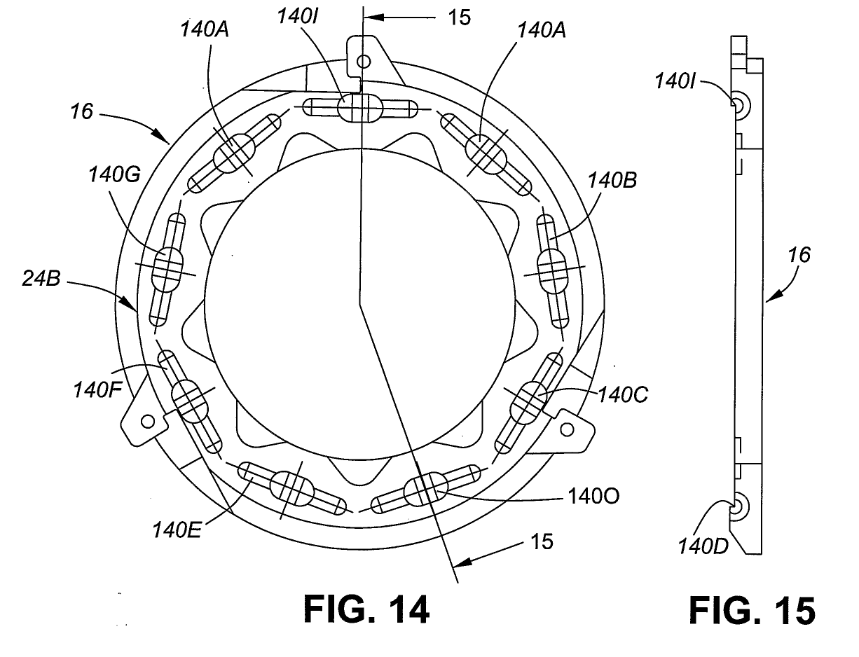

FIG. 14 is a plan view of a pressure plate 16 with a modified annular rim 24B according to a third embodiment of the present invention. The annular rim 24B defines a plurality of recesses 140A, 140B, . . . , 140I.

FIG. 15 is a side sectional view of the pressure plate 16 taken along line 15-15 of FIG. 14, showing two recesses 140I and 140D.

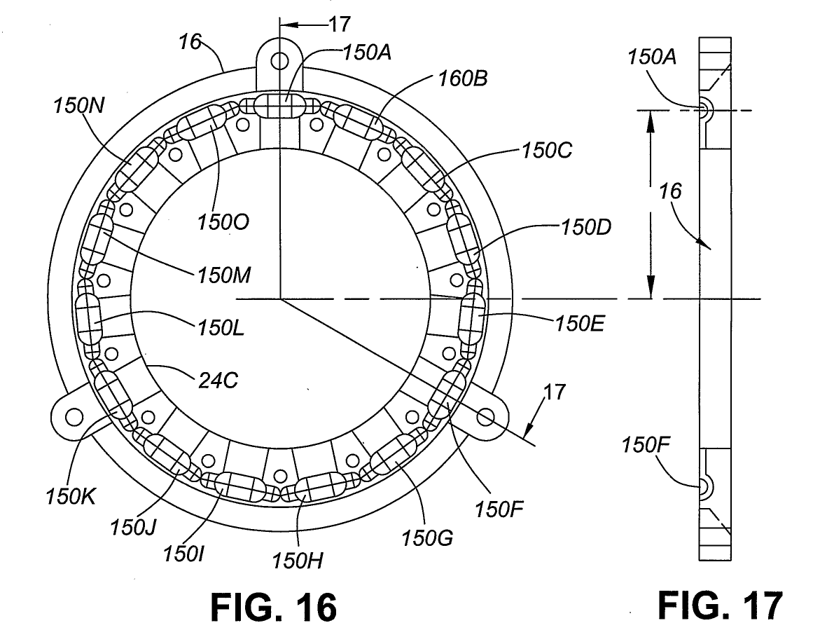

FIG. 16 is a plan view of a modified pressure plate 16 with a plurality of shafts and corresponding rotational bearings according to a fourth embodiment of the present invention. In FIG. 16, the annular rim provides a plurality of recesses 150A, 150B, . . . , 150O, that are in close proximity. The edge of each recess forms an edge of the recess contiguously disposed beside the recess, i.e. a shaft portion of recess 150A edges with a shaft portion of recess 150B.

FIG. 17 is a side sectional view of the pressure plate 16 with a modified annular rim 24C taken along line 17-17 of FIG. 16, showing two recesses 150A and 150F.

While the pressure plate 16 shown in FIGS. 12 through 17 each have an annular rim 24A, 24B, 24C, with an odd number of recesses, the present invention may be contemplated with an even number of recesses and corresponding shafts and rotational bearings. The present invention is also not limited to a number of bearing contacts formed between the spring diaphragm 30 and the pressure plate 16, i.e., there may be fewer or more recesses than shown in FIGS. 12 through 17, provided the dimensions of the recesses and corresponding shafts and rotational bearings are also adjusted.

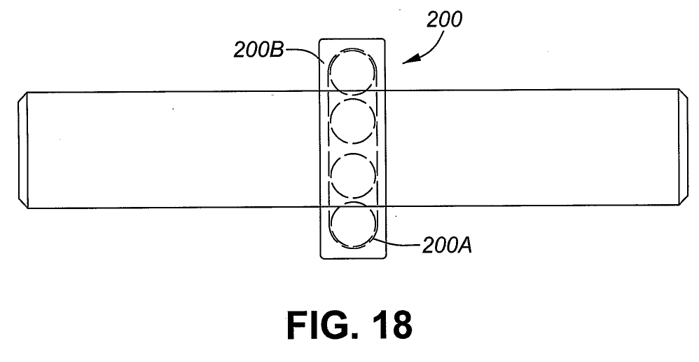

FIG. 18 is a partial cross-sectional view of a shaft and rotational bearing arrangement using a spherical ball bearing 200. The spherical ball bearing 200 consists of a plurality of spherical balls 200A and a spherical ball bearing cage 200B surrounding the balls.

According to the present invention, the shaft and bearing arrangement can be made of but not limited to any of the following: cast steel, carbon steel, brass, brass impregnated with oil, or a steel alloy. The manufacturing processes may include a digitized milling machine of the CNC variety for accurate machining of the raw material. Any type of pressure plate utilized in a clutch cover assembly may be modified according to the present invention. By using pressure plates of the prior art, high precision machining of those plates would likely avoid an increase in manufacturing defects typical of any new component manufacturing process.

It should be understood that the preferred embodiments mentioned here are merely illustrative of the present invention. Numerous variations in design and use of the present invention may be contemplated in view of the following claims without straying from the intended scope and field of the invention herein disclosed.

Having thus described the invention, what is claimed as new and secured by Letters Patent is:

1. An automotive clutch system having a clutch disc supported by a flywheel and a pressure plate with a spring diaphragm biased by a release mechanism operating between the pressure plate and a clutch cover to compress the clutch disc between the pressure plate and the flywheel in engagement and to release the clutch disc from the flywheel in disengagement, the pressure plate in bearing contact with the spring diaphragm, the pressure plate forming a substantially annular ring with a smooth undersurface, and an upstanding rim on an upper surface of the pressure plate, wherein the release mechanism comprises:
a plurality of shafts and corresponding rotational bearings as the bearing contact, each shaft and corresponding rotational bearing arranged such that the rotational bearing is mounted on the shaft for rotational movement about the shaft; and
the pressure plate having radially spaced apart recesses in the upper surface of the pressure plate for retaining the each shaft and corresponding rotational bearing for free rotation about the shaft, the rotational bearing and the pressure plate being vertically displaced as the spring diaphragm is shaped for engagement and disengagement of the clutch.

2. The clutch system as in claim 1, wherein each rotational bearing is a spherical ball bearing.

3. The clutch system as in claim 1, wherein each rotational bearing is a needle bearing.

4. The clutch system as in claim 1, wherein the plurality of shafts and corresponding rotational bearings includes an even number of shafts and rotational bearings.

5. The clutch system as in claim 1, wherein the plurality of shafts and corresponding rotational bearings includes an odd number of shafts and rotational bearings.

6. The clutch system as in claim 1, wherein the clutch system is a pull-off type clutch system.

7. The clutch system as in claim 1, wherein the clutch system is a push-off type clutch system.

8. The clutch system as in claim 1, wherein the plurality of shafts and corresponding rotational bearings are made of material selected from the group consisting of: cast steel, carbon steel, and alloy steel.

9. The clutch system as in claim 1, wherein the radially spaced apart recesses are dimensioned to permit axial movement of each corresponding rotational bearing along the shaft centers itself on the shaft when the spring diaphragm is shaped for engagement and disengagement of the clutch disc.

10. The clutch system as in claim 1, wherein the annular ring of the pressure plate defines a circumference, and wherein each of the recesses defines a longitudinal axis that is tangential to the circumference of the annular ring.

11. An automotive clutch system having a clutch disc supported by a flywheel and a pressure plate with a spring diaphragm biased by a release mechanism operating between the pressure plate and a clutch cover to compress the clutch disc between the pressure plate and the flywheel in engagement and to release the clutch disc from the flywheel in disengagement, the pressure plate forming a substantially annular ring with an undersurface that engages the clutch disc, and the pressure plate having an upstanding rim on an upper surface of the pressure plate, the spring diaphragm being shaped for engagement and disengagement, the pressure plate in bearing contact with a base end of the spring diaphragm such that the spring diaphragm is shaped for engagement to transfer a force through the release mechanism to the pressure plate to engage the clutch disc, and when shaped for disengagement, releases the transfer of force to the pressure plate via the release mechanism, wherein the release mechanism comprises:
a fulcrum support extending from the clutch cover and operatively coupled to a diaphragm spring such that the base end of the spring diaphragm is movable from the fulcrum support to displace the pressure plate;
a plurality of shafts and corresponding rotational bearings as the bearing contact, each shaft and corresponding rotational bearing arranged such that a needle bearing is mounted on the shaft for rotational movement about the shaft; and
the upstanding rim of the pressure plate defining radially spaced apart recesses in the upper surface of the pressure plate for retaining the each shaft and corresponding rotational bearing for free rotation about the shaft.
